(19) United States
(12) Patent Application Publication
(10) Pub. No.: US 2015/0040733 A1
(43) Pub. Date: Feb. 12, 2015

(54) PATTERNS TO GUIDE HAIRCUTTING

(71) Applicant: Equip Beauty, Inc., Palo Alto, CA (US)

(72) Inventor: Rachel Croft, Palo Alto, CA (US)

(21) Appl. No.: 14/456,490

(22) Filed: Aug. 11, 2014

Related U.S. Application Data
(60) Provisional application No. 61/864,846, filed on Aug. 12, 2013.

(51) Int. Cl. A45D 24/36; B26B 29/06

(52) U.S. Cl. CPC A45D 24/36; B26B 29/06
USPC 83/13; 132/214

(57) ABSTRACT

Described herein are haircutting patterns for use when cutting hairs, and methods for use therewith. In an embodiment, a haircutting pattern includes a spine and a plurality of threads extending from the spine. The spine is configured to be affixed to hairs and/or a scalp. The threads are configured to be visibly distinguishable among hairs. In certain embodiments, free ends of the threads define a perimeter shape of a haircut and thereby provide a guide for cutting hairs. In certain embodiments, different portions of the threads are different colors, and different perimeter shapes are defined by where different colors end. In certain embodiments, different colored lines on the threads define different perimeter shapes for a haircut.

### PRIORITY CLAIM

This application claims priority to U.S. Provisional Patent Application No. 61/864,846, filed Aug. 12, 2013, which is incorporated herein by reference.

### FIELD OF THE INVENTION

Embodiments of the present invention relate to apparatuses and methods for use in cutting hairs.

### BACKGROUND OF THE INVENTION

Haircutting requires considerable skill. Individuals typically attend cosmetology school to learn how to safely and effectively cut hairs. When a novice tries to cut hairs, they may find that it is difficult to cut hairs in a straight line or in the shape they want. The individual strands in a given section should be combed straight, secured, and then cut carefully to ensure a straight line is created in that section. To cut the hairs on the whole head, this should be done repeatedly, with many sections combined creating the haircut. Since the entire head cannot be viewed at once, it is difficult to know if a section of hairs on one side of the head is the same length or symmetrical to a section of hairs on the other side of the head.

The perimeter shape of a haircut is important because it creates the basic framework for the haircut, on top of which layers or texture can be created, if desired. As the term is used herein, the “perimeter” refers to the shape created by the hairs that correspond to the bottom margin of a haircut, as can be appreciated from FIGS. 1A, 1B and 1C. If the perimeter is badly shaped, uneven, or unintentionally asymmetrical, the haircut can look unkempt. Different haircuts require different perimeter shapes. Some haircuts require that the perimeter is shorter in the front than in the back, as shown in FIG. 1A. Other haircuts require that the perimeter is shorter in the back than in the front, as shown in FIG. 1 B. Still other haircuts require that the perimeter is a straight line all around the circumference of the head, as shown in FIG. 1C. Haircuts can also require a perimeter, or portion thereof, that is concave, convex, or asymmetrical, but are not limited thereto. Such perimeter shapes are difficult to achieve using only the eyes of the haircutter for guidance, especially where the haircutter (i.e., the person cutting the hairs) is a novice. Additionally, even where the haircutter is experienced, it may be difficult for the haircutter to consistently achieve a same perimeter shape, or to learn how to achieve a perimeter shape they have not previously achieved.

### BRIEF DESCRIPTION OF THE DRAWINGS

FIGS. 1A, 1B and 1C illustrate different perimeter shapes associated with different haircuts.

FIGS. 2A and 2B illustrates two different patterns for cutting hairs according to specific embodiments of the present invention.

FIGS. 3A illustrates a pattern, according to an embodiment of the present invention, that can be used to achieve a haircut where a perimeter shape is straight.

FIGS. 3B illustrates a pattern, according to an embodiment of the present invention, that can be used to achieve a haircut where a perimeter shape is longer in the back than in the front.

FIG. 3C illustrates a pattern, according to an embodiment of the present invention, which is useful for cutting bangs.

FIGS. 3D illustrates a pattern, according to an embodiment of the present invention, that can be used to achieve a haircut where a perimeter shape is longer in the front than in the back.

FIGS. 3E illustrates a pattern, according to an embodiment of the present invention, that is used to cut hairs on the back of the head.

FIG. 4 illustrates that one pattern can be used to guide the cutting of hairs in the front, and another pattern can be used to guide the cutting of hairs in the back.

FIG. 5A illustrates a spine of a pattern that lies along the hair part of a person's head.

FIG. 5B illustrates a spine of a pattern that lies on a part created from right to left.

FIG. 5C illustrates a spine that is configured to be placed around the crown of a head.

FIGS. 6A, 6B and 6C illustrates spines of patterns of various different embodiments of the present invention, wherein threads extend from the spines in various different manners.

FIGS. 7A and 7B illustrate a pattern that enables the length of threads to be adjusted in accordance with an embodiment.

FIG. 8 illustrates a pattern having threads in which different portions of the threads have different colors to thereby define different perimeter shapes for a haircut.

FIG. 9 illustrates a pattern having threads in which different colored lines define different perimeter shapes for a haircut.

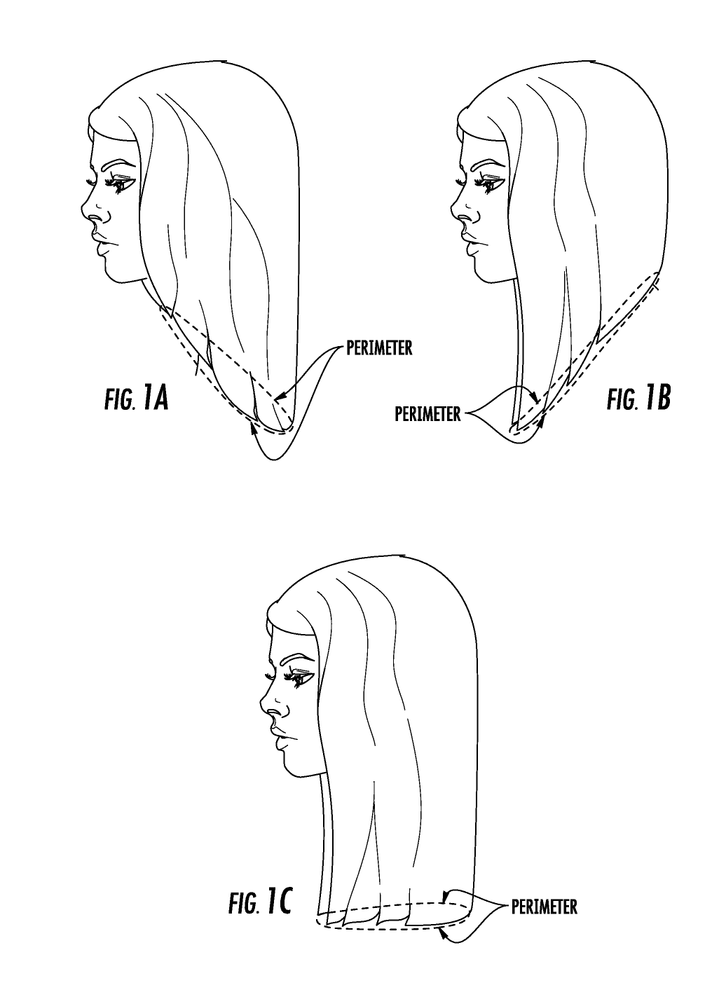

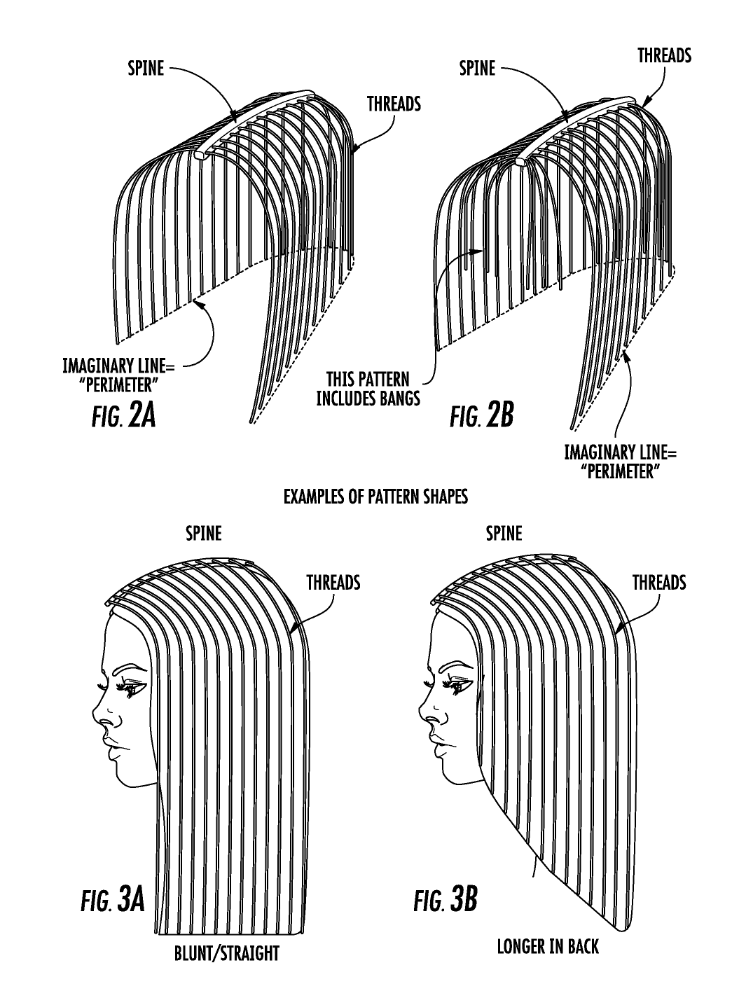

### DETAILED DESCRIPTION

Embodiments of the present invention, which are disclosed herein, are useful for aiding in creating a desired perimeter shape for a haircut. In accordance with specific embodiments, patterns, which include threads of pre-defined or customizable lengths, are configured to be laid on a head of a person (or a mannequin) and combed along with the hairs of the person (or the mannequin). The threads remain visible among the hairs so that the haircutter can cut the ends of the hairs even with the ends of the threads or some other marker along the length of the threads. The hairs may be cut with scissors, a hair clipper or any other haircutting instrument capable of cutting hairs.

In accordance with specific embodiments, a pattern includes a spine for positioning the pattern on the head, and threads that emanate from the spine, as shown in FIGS. 2A and 2B. The spine of the pattern, which can also be referred to as the base, can be configured to be laid upon a hair part, which has been created at the center of the scalp from top middle of the forehead to the apex of the head, or in some other chosen position. The spine can be attached using water soluble glue to the area of the scalp demarcated by the parting in the hair, or can be attached to the hair on either side of the part using clips or some other attachment means. Threads that emerge from the spine can be combed or brushed into the hairs so that each thread lies along a natural fall line of the hairs. For straight hair, the threads will lie straight along with the natural strands of hair. For curly hairs, it may be beneficial that the hairs are wetted or ironed straight so that the threads of the pattern can more readily approximate a fall line of the hairs. Alternatively, for curly hair, the threads that comprise the pattern may be curly to approximate the natural curls of the hair.

In accordance with certain embodiments, the threads are a different color than the hairs so that they can be more readily seen on top of the hairs or if they mix with the hairs. For example, the color of the threads can be neon yellow, neon green, neon pink, neon purple, neon orange, electric blue or any other bright color that will likely contrast most peoples' hair colors. Threads of other colors can alternatively be used. More generally, the threads are preferably a bright color (examples of which were provided above) that differs from known natural hair colors. When the pattern is placed in the correct position, and the threads are combed along with the hairs, the ends of the threads define where the hairs should be cut. When the haircutter cuts the hairs to match the ends of the threads, the resulting perimeter shape of the cut hairs will be the same as the pattern. Alternatively, the pattern may be made of up threads that transition between colors such that cutting along one color line results in a certain perimeter shape, and cutting along a different color line results in a different perimeter shape. It is also noted that similarly shaped haircuts (e.g., two haircuts that have ends that are in a straight line that is parallel to the ground) that are of different hair lengths are considered, for the purpose of this description, to correspond to different perimeter shapes. For a more specific example, a short straight haircut is considered to have a different perimeter shape than long straight haircut.

Because different people have different head sizes, shapes and hair growth patterns, patterns may fit people differently, or may look different on different head shapes. To account for this, in accordance with certain embodiments, patterns have customizable features, which are described below.

In accordance with certain embodiments, the length of a spine of a pattern can be shortened or lengthened to better match the dimensions of a person's head. More specifically, in certain embodiments the length of the spine can be adjusted to match a distance from the top of the forehead to the apex of the head, or more generally, to match the length of a center hair part. In an embodiment, this can be done by cutting off a portion of the front and/or back of the spine. In another embodiment, this can be done by sliding a moveable overlapping section in the middle of the spine. In still another embodiment, this can be accomplished by overlapping the spine on itself and securing it in position. In a further embodiment, the spine can include an elastic material which can be stretched onto a rigid member of the spine which is customized for the user's anatomy. Further embodiments encompass combinations of aforementioned embodiments.

Patterns can be designed in a variety of shapes, sizes and lengths so that the ends of the threads define various different desired perimeter shapes. Different head shapes (for example, more or less rounded) can affect the perimeter shape created by a given pattern. To account for this, in certain embodiments the lengths of the threads on a pattern can be adjustable. In an embodiment, the threads in certain locations along the spine may be pulled up or down through the spine until the bottom of the threads define the desired perimeter length and shape. The threads can then be secured so that the pattern can be used in the newly adjusted configuration. Alternately, the threads could be adjusted by simply cutting the ends of the threads to make them conform with the desired perimeter, then using the pattern to cut the hair. To aid in the cutting of the threads, various lines can be imprinted on the threads that enable the threads to be cut in a manner that maintains a desired perimeter shape.

In accordance with an embodiment, a pattern can include very long threads that enable a customer to customize the pattern herself/himself. In such an embodiment, threads of the pattern can be cut to the desired length and shape before the pattern is secured in place and used to cut hairs to match the pattern.

In another embodiment, a pattern can have fully adjustable threads. In such an embodiment, the threads can be pulled up or down through the spine until the free ends define the desired perimeter shape. Then the portions of the threads adjacent the spine can be secured in place to secure the perimeter shape.

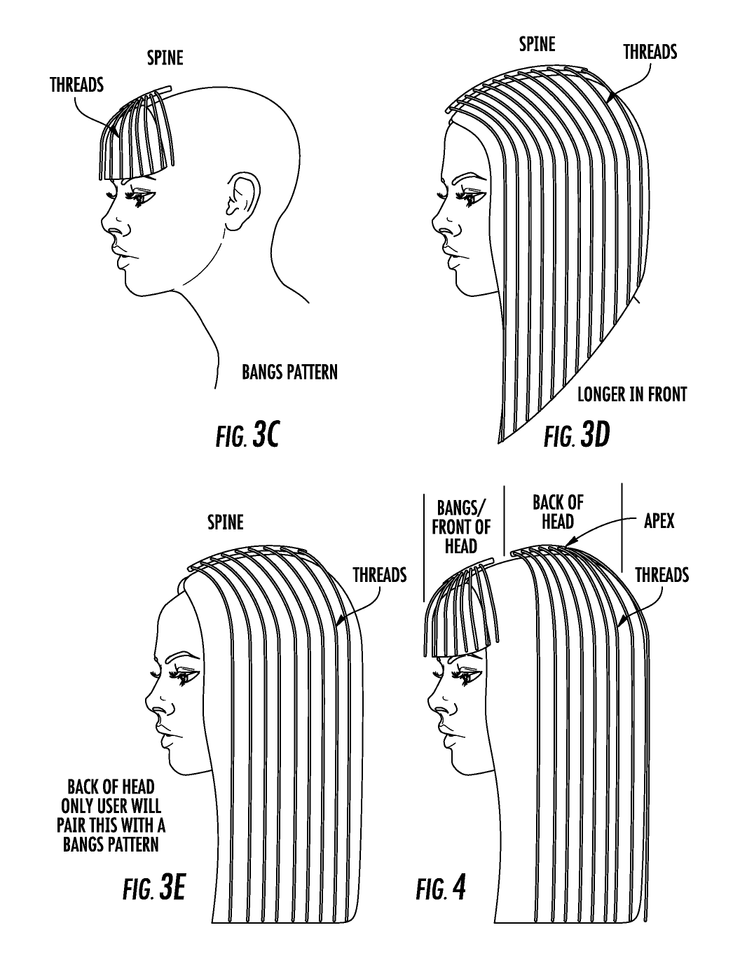

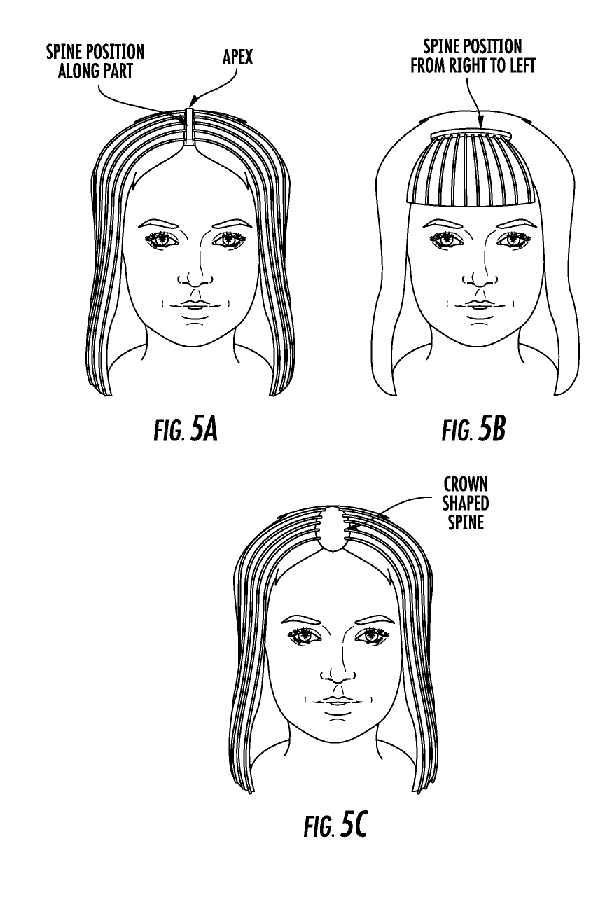

Patterns can be made for a whole head, as shown in FIGS. 3A, 3B and 3D. Alternatively, a pattern can be made for bangs only, and thus, can be made for only the front of a head, as shown in FIG. 3C. In still other embodiments, a pattern can be made only for the back of the head, as shown in FIG. 3E. FIG. 4 shows general regions of back of head versus front of the head. Users may use a whole head pattern, a bangs-only pattern, a back only pattern, or mix and match patterns for the back of the head and the bangs. For example, where a user uses a first pattern for their bangs, and a second pattern for the back of their head, each pattern will include its own spine and its own threads that emanate from the spine. The two spines can remain apart. Alternatively, the spine of the pattern for the bangs can be connected to the spine of the pattern for the back of the head, e.g., using Velcro, snaps, glue and/or some other means, or simply placed into position and attached to the hairs and/or scalp directly.

FIG. 5A illustrates a spine of a pattern that lies along the hair part of a person's head. Alternative designs allow the spine to lie on a part created from right to left, as shown in FIG. 5B. It is also possible that the spine is oval or circular, or includes an oval or circular portion, which is configured to be placed around the crown of a head, as shown in FIG. 5C.

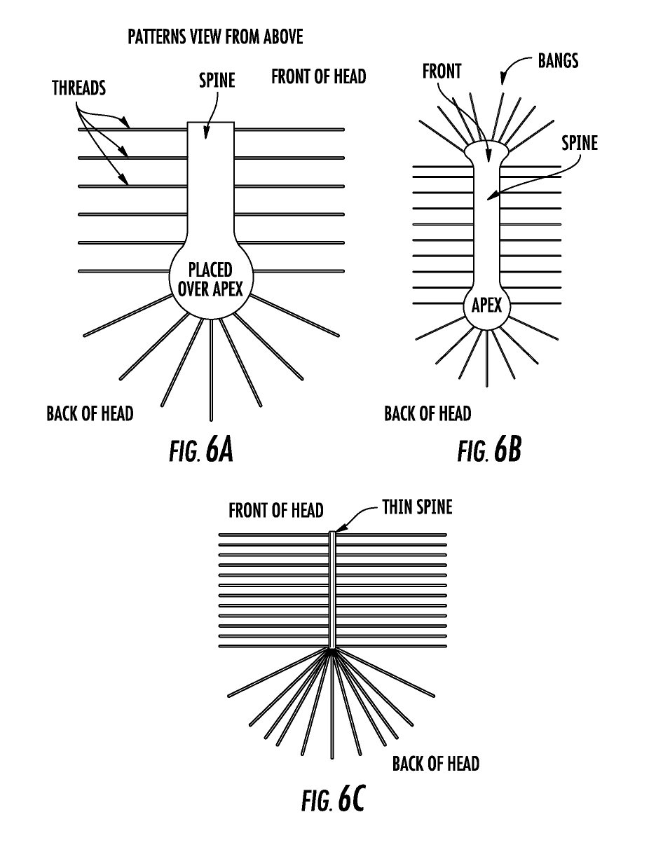

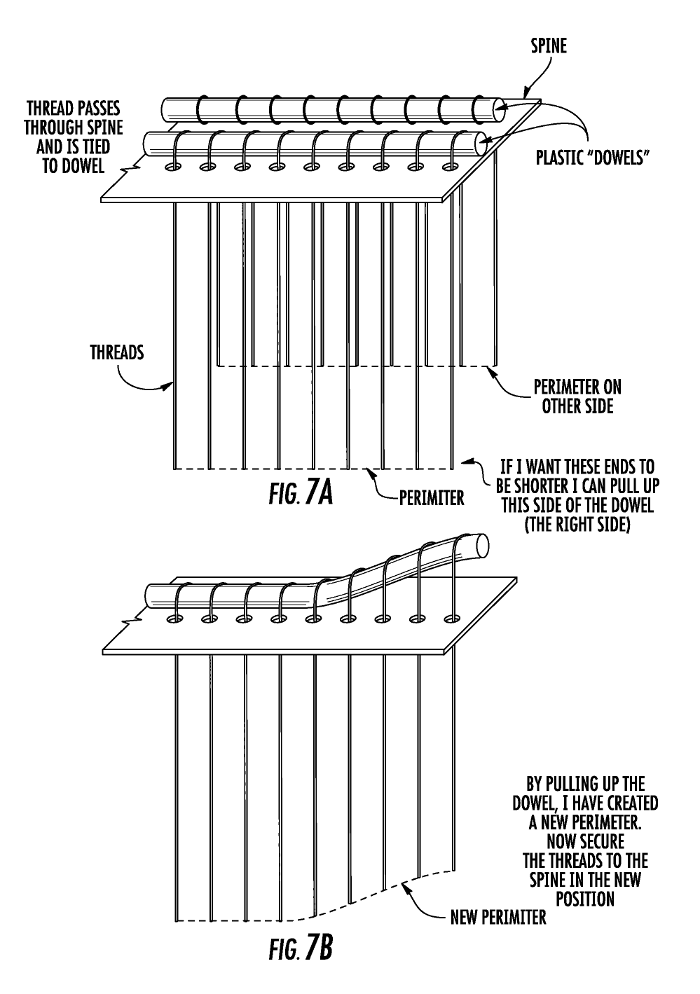

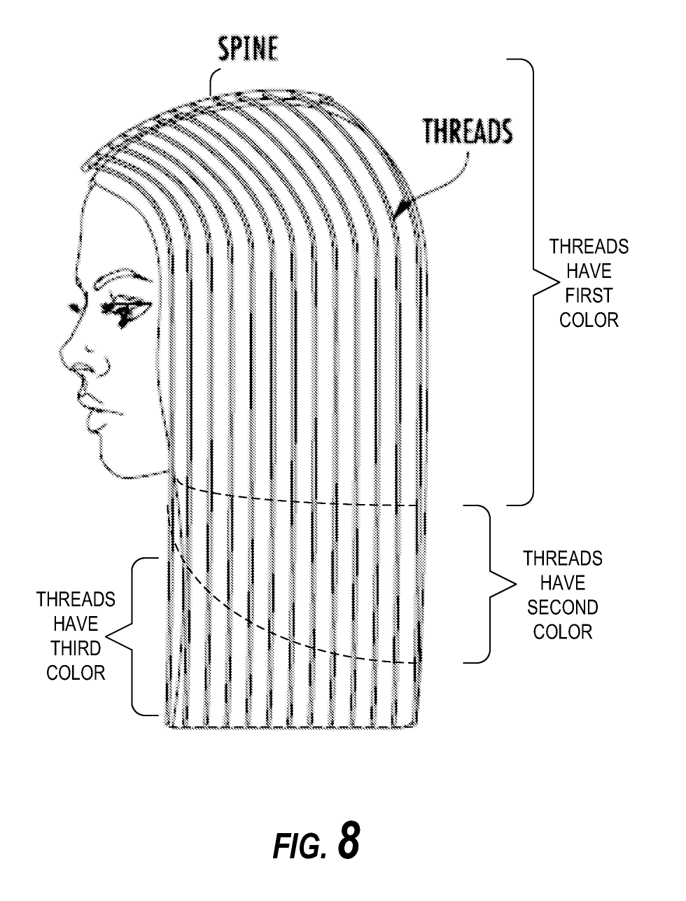

A pattern can have a long thin spine with threads extending from both sides, as shown in FIG. 6C. The end of the pattern that is placed on the apex of the head may have threads that emanate in 180 degrees, as shown in FIG. 6A, 6B and 6C, to account for the fact that the hairs on this area of the head fall to the right, left and back of the head, whereas hairs on the sides of the head primarily fall in one direction. A pattern may have a shaped spine that may include a rounded end at the back such that if threads are connected to the edges of the spine, they will fall to the sides of the head in the front to middle sections, and they will fall in 180 degrees around the back section, as shown in FIG. 6A and 6B. Similarly, a shaped spine may include a rounded section at the front such that if threads are connected to the edges of the spine, they will fall in 180 degrees around the front end of the spine, as show in in FIG. 6B, simulating the natural pattern of the bangs.

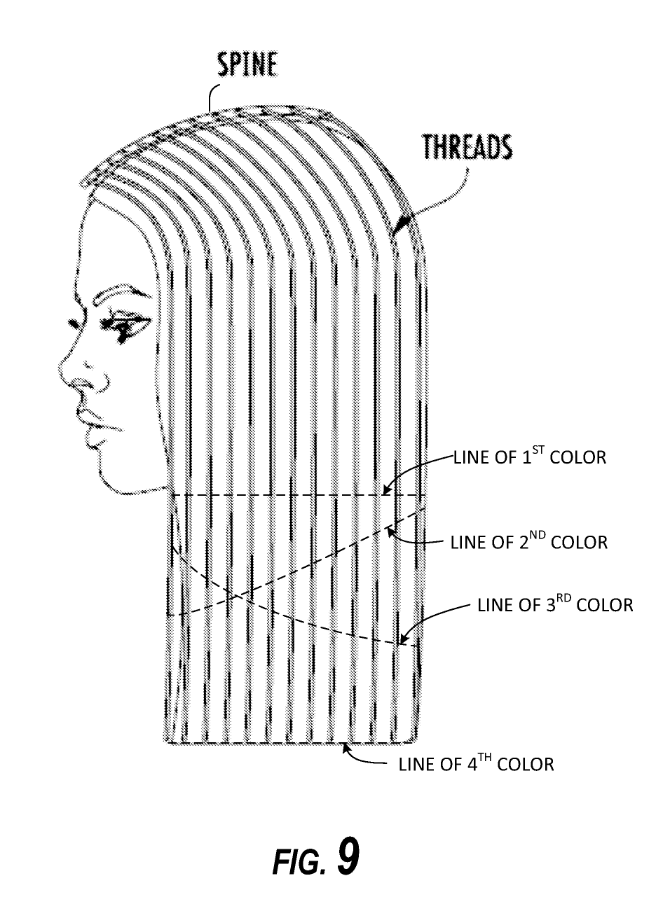

The spine may be made of various different types of materials, such as, but not limited to, fabric, plastic, Velcro, elastic, and/or other materials that enable threads to be affixed to the spine and allows the spine to be placed upon a head. The spine should preferably provide some support for the threads of the pattern so that the threads are not easily pulled out of alignment. In certain embodiments, a spine includes holes for the threads to pass through so that the threads may be adjustable in length. In certain embodiments the spine may also contain some feature that allows the hairs near each other to be moved with some uniformity. For example, threads can be attached to a flexible plastic dowel, as shown in FIG. 7A, and the dowel may be pulled away from the spine in a certain location to shorten the threads in that location, as shown in FIG. 7B. The dowel enables the surrounding threads to move somewhat in conjunction with each other. The threads can then be secured in the new position. The spine may be made of a single layer of material, or two or more layers. For instance, one layer of the spine can be made of Velcro with the attachment side up, the threads could pass through this layer, and once the threads are in the confirmed correct position, a second complementary layer of Velcro can be attached on top to secure the threads in that position.

The threads may be made of various different types of materials, such as, but not limited to, sewing thread, plastic, and/or any other material formed in strands so that they may be combed along with the hair and are visible among the hairs. The threads are preferably made of a material that does not stretch when pulled, so that the lengths of the threads remain consistent despite various degrees of pulling on the threads during combing or brushing. In certain embodiments, the entire lengths of the threads are the same color. In other embodiments, the ends of the threads that are used to define the perimeter shape are a different color from the remaining portions of the threads, so as to make the ends of the threads more easily noticed. In other embodiments, the threads may have multiple colors, each color indicating a different perimeter shape. The diameter of the threads is preferably thicker than that of human hairs, but is preferably thin enough that the threads can be combed or brushed together with hairs. In accordance with certain embodiments, the diameter of the threads is within the range from about 0.1 mm to about 1.0 mm. Alternative thread diameters are also possible.

FIG. 8 illustrates an embodiment where a first portion of the threads of a pattern is a first color, a second portion of the threads is a second color (that differs from the first color), and a third portion of the threads is a third color (that differs from the first and second colors). In this embodiment, a first perimeter shape of a haircut is defined by where the first color ends; a second perimeter shape of a haircut is defined by where the second color ends; and a third perimeter shape of a haircut is defined by where the third color ends. More or less than three colors are also possible. In this embodiment, the threads of the pattern may also be cut when cutting hairs. More specifically, cutting ends of hairs (and the pattern) to be substantially even with where the first color ends results in a first perimeter shaped haircut. Cutting ends of the hairs (and the pattern) to be substantially even with where the second color ends results in a second perimeter shaped haircut. Cutting ends of the hairs to be substantially even with where the third color ends (which can be the same as where the threads end) results in a third perimeter shaped haircut. In the above described embodiment, where the first color ends is the same as where the second color begins. In other words, the first color ends at the transition from the first color to the second color, wherein the transition can also be referred to as a color line. Similarly, where the second color ends is the same as where the third color begins. In other words, the second color ends at the transition from the second color to the third color. Such multicolored patterns can be used for cutting hairs on the whole head, e.g., as shown in FIG. 8, or for cutting hairs on only a certain portion of the head, such as just for the bangs (on the front of the head), or just for hairs on the back of the head.

FIG. 9 illustrates an embodiment where all the threads primarily have the same color (e.g., white or yellow), but there are different colored lines visible at different points along the threads, each of which corresponds to a different perimeter shape. For example, referring to FIG. 9, there can be a line having a first color (e.g., bright orange) that corresponds to a first perimeter shape where the hairs are short and straight, a line having a second color (e.g., bright green) that corresponds to a second perimeter shape where the hairs are generally short but longer in the front than in the back, a line having a third color (e.g., bright pink) that corresponds to a third perimeter shape where the hairs are generally of medium length with the hairs shorter in the front than the back, and a line having a fourth color (e.g., bright blue) that corresponds to a fourth perimeter shape where the hairs are long and straight. One or more of the aforementioned lines may overlap one another. For example, in FIG. 9, the line of the third color overlaps the line of the fourth color. More or less than four colored lines are also possible. In this embodiment, the threads of the pattern may also be cut when cutting hairs. More specifically, cutting ends of hairs (and the pattern) to be substantially even with the line of the first color results in a first perimeter shaped haircut. Cutting ends of the hairs (and the pattern) to be substantially even with the line of the second color results in a second perimeter shaped haircut. Cutting ends of the hairs (and the pattern) to be substantially even with the line of the third color results in a third perimeter shaped haircut. Cutting ends of the hairs to be substantially even with where the line of the fourth color (which can be the same as where the threads end) results in a fourth perimeter shaped haircut. In other words, cutting along different colored lines of the pattern results in different perimeter shaped haircuts.

In the embodiments described with reference to FIGS. 8 and 9, different demarcation lines included on the threads define different perimeter shapes of a haircut. In the embodiment described with reference to FIG. 8, the demarcation lines correspond to where one color transitions to another color, or more generally, where each color ends. For example, in FIG. 8 a first demarcation line, which corresponds to where a first color ends, defines a first perimeter shape of a haircut; a second demarcation line, which corresponds to where a second color ends, defines a second perimeter shape of a haircut; and a third demarcation line, which corresponds to where a third color ends, defines a third perimeter shape of a haircut. In the embodiment described with reference to FIG. 9, the demarcation lines correspond to the different colored lines. For example, in FIG. 9 the threads include a line having a first color, which corresponds to a first demarcation line that defines a first perimeter shape; the threads include a line having a second color, which corresponds to a second demarcation line that defines a second perimeter shape; the threads include a line having a third color, which corresponds to a third demarcation line that defines a third perimeter shape; and the threads include a line having a fourth color, which corresponds to a fourth demarcation line that defines a fourth perimeter shape. The longest perimeter shape can alternatively simply be defined by the ends of the threads. In other words, the demarcation line that defines the longest hair perimeter shape may be defined by the ends of the threads, and not necessarily (but potentially also) the end of a color or a colored line.

The haircutting patterns described herein can be manufactured and sold as a one-size fits all product. Such a one-size fits all products may not be adjustable. Alternatively, such a one-size fits all product can include a spine having an adjustable length and/or can include threads having an adjustable length. The haircutting patterns described herein can alternatively be manufactured and sold in different sizes. For example, there can be a child size and an adult size, which takes into account that the average size head of children and the average size head of adults differ, and that appropriate hair lengths may differ between children and adults considering that the average distance between the top of the head and shoulders is different between children and adults. It is also possible that the haircutting patterns described herein can be manufactured and sold in numerous different sizes, e.g., for different head diameters and/or different distances between the top of the head and shoulders. Other variations are also possible and within the scope of an embodiment of the present invention. For example, there can be different patterns manufactured and sold for different hair styles. For another example, there can be female haircutting patterns and separate male haircutting patterns.

In embodiments where threads of a pattern is intended to be cut at the same time that hairs are being cut, by cutting along a demarcation line, the pattern can be reused in the future to cut that same perimeter shaped haircut. It is also possible that a pattern including multiple different demarcation lines is cut along one the demarcation lines before the spine of the pattern is affixed to hairs and/or a scalp. In this case, the free ends of the threads (after they are cut) will define a perimeter shape of a haircut, similar to in the embodiments described above with reference to 3A-3D.

A pattern can be attached to a scalp and/or hairs in various different manners. In certain embodiments, the spine and/or threads of a pattern are attached to hairs by clips or bobby pins. Alternatively the spine may include tabs that can be attached to the hairs below, such that the threads lie freely on top of the tabs. One or more clips or bobby pins can be permanently attached to spine. Alternatively, one or more clips can come in a same package as a pattern and can be used to attach the spine and/or threads of the pattern to hairs of a head. In an embodiment, the clips have a non-slip (e.g., rubberized, tacky and/or textured) coating to help affix a pattern to the hairs and prevent a spine of the patterns from moving when the threads of the pattern are combed into the hair. In an embodiment, a spine includes openings or pockets through which portions of a clip can be inserted. Additionally, or alternatively, a portion of the spine intended to contact the head can include a water-soluble adhesive that is covered by a removable backing strip that when removed exposes the adhesive, which can be used to adhere the spine to a scalp and/or hairs. Alternatively, a water-soluble glue that comes in a tube or other dispenser can be used to attach a spine of a pattern to a scalp at a hair part.

In an embodiment, the threads include an indicator at their ends (e.g., electrical or chemical) that is identifiable by a haircutting tool so that the haircutting tool beeps, illuminates, or vibrates to indicate the end of the thread has been reached, or so that the haircutting tool is actuated to cut the hair automatically.

In an embodiment, the ends of the threads can contain washable dye. When the ends are in the correct position, the ends can be squeezed, releasing the dye into the hair at the correct position, indicating where the hair should be cut. In another embodiment, the threads can be tubes containing dye. When the ends of the threads are in the correct position, the dye is injected out to mark the hairs, indicating where they should be cut.

Embodiments of the present invention described above can be used by a person to cut their own hairs. Alternatively, embodiments of the present invention described above can instead be used by a person to cut another person's hairs.

Embodiments of the present invention are also directed to methods of cutting hairs using the patterns described above. Such methods can include attaching a spine and/or threads of a pattern to a head, brushing or combining the threads and the hairs so that the threads lie along a fall line of the hair, and cutting ends of the hairs to be substantially even with ends of the threads or some other indicated point (e.g., where a color ends) along the threads. More specifically, as was described above with reference to FIGS. 8 and 9, such methods can include cutting hairs (and the pattern) along one of a plurality of different demarcation lines included on the threads, wherein each of the demarcation lines defines a different perimeter shape. Such methods can also include adjusting the length of the spine and/or lengths of the threads, as can be appreciated from the above descriptions of the various embodiments of the patterns.

The previous description of the preferred embodiments is provided to enable any person skilled in the art to make or use the embodiments of the present invention. While the invention has been particularly shown and described with reference to preferred embodiments thereof, it will be understood by those skilled in the art that various changes in form and details may be made therein without departing from the spirit and scope of the invention. For example, combinations of the various embodiments described above are also within the scope of the present invention.

What is claimed is:

1. A haircutting pattern for use when cutting hairs, comprising:
a spine configured to be affixed to at least one of hairs or a scalp; and
a plurality of threads extending from the spine;
wherein the threads are configured to be visibly distinguishable among hairs;
wherein the threads are configured to be at least one of brushed or combed with hairs so that the threads lie along one or more fall lines of the hairs; and
wherein free ends of the threads define a perimeter shape of a haircut and thereby provide a guide for cutting hairs.

2. The haircutting pattern of claim 1, wherein the spine has a substantially constant width along its length and is configured to be placed along a part in the hairs.

3. The haircutting pattern of claim 1, wherein the spine has or includes an oval or circular shape that is configured to be placed on a crown of a head.

4. The haircutting pattern of claim 1, wherein the threads extend from only one side of the spine, in a direction that is perpendicular to a length of the spine, and wherein the free ends of the threads provide a guide for cutting bangs.

5. The haircutting pattern of claim 1, wherein a length of the elongated spine is adjustable.

6. The haircutting pattern of claim 1, wherein lengths of at least some of the threads are adjustable.

7. The haircutting pattern of claim 1, wherein the threads comprise curly threads.

8. The haircutting pattern of claim 1, further comprising one or more clips or tabs to attach at least a portion of the spine and/or at least some of the threads to hairs.

9. The haircutting pattern of claim 8, wherein the one or more clips or tabs have a non-slip coating.

10. The haircutting pattern of claim 1, wherein at least some of the threads include an indicator at their free ends that is identifiable by a haircutting tool and causes the haircutting tool to at least one of beep, illuminate, vibrate or activate when the haircutting tool is aligned with the free ends of the threads.

11. The haircutting pattern of claim 1, wherein a diameter of the threads is within a range from about 0.1 mm to about 1.0 mm.

12. The haircutting pattern of claim 1, wherein the threads are a bright color that differs from natural hair colors.

13. The haircutting pattern of claim 1, wherein the spine includes:
first and second longitudinal ends that oppose one another and define a length of the spine therebetween; and
first and second sides that oppose one another and define a width of the spine therebetween;
wherein a first plurality of the threads extend perpendicularly from the first side of the spine;
wherein a second plurality of the threads extend perpendicularly from the second side of the spine; and
wherein a third plurality of the threads extend from one of the first or second longitudinal ends in an approximately 180 degree pattern.

14. A method for cutting hairs, comprising:
(a) attaching a portion of a haircutting pattern to at least one of a scalp or hairs of a head, wherein the haircutting pattern includes a spine and a plurality of threads extending from the spine which are visibly distinguishable from the hair;
(b) at least one of brushing or combing the threads and the hairs so that the threads lie along one or more fall lines of the hair; and
(c) cutting ends of the hairs to be substantially even with ends of the threads.

15. The method of claim 14, further comprising:
adjusting a length of the spine prior to the cutting at step (c).

16. The method of claim 14, further comprising:
adjusting a length of at least some of the threads prior to the cutting at step (c).

17. A haircutting pattern for use when cutting hairs, comprising:
a spine configured to be affixed to at least one of hairs or a scalp; and
a plurality of threads extending from the spine;
wherein different demarcation lines included on the threads define different perimeter shapes of a haircut.

18. The haircutting pattern of claim 17, wherein:
a first portion of at least some of the threads is a first color, and a second portion of the at least some of the threads is a second color that differs from the first color;
a first demarcation line, which corresponds to where the first color ends, defines a first perimeter shape of a haircut; and
a second demarcation line, which corresponds to where the second color ends, defines a second perimeter shape of a haircut.

19. The haircutting pattern of claim 17, wherein:
the threads include a line having a first color, which corresponds to a first demarcation line that defines a first perimeter shape;
the threads include a line having a second color, which corresponds to a second demarcation line that defines a second perimeter shape; and
the first and second colors differ from one another.

20. The haircutting pattern of claim 19, wherein the first and second demarcation lines intersect one another.

21. A method for cutting hairs, comprising:
(a) attaching a portion of a haircutting pattern to at least one of a scalp or hairs of a head, wherein the haircutting pattern includes a spine and a plurality of threads extending from the spine, wherein different demarcation lines included on the threads define different perimeter shapes of a haircut;
(b) at least one of brushing or combing the threads and the hairs so that the threads lie along one or more fall lines of the hair; and
(c) cutting ends of the hairs to be substantially even with one of the demarcation lines, such that cutting ends of the hairs to be substantially even with a first demarcation line results in a first perimeter shaped haircut, or cutting ends of hairs to be substantially even with a second demarcation line results in a second perimeter shaped haircut that differs from the first perimeter shaped haircut.

22. The method of claim 21, wherein:
a first portion of at least some of the threads is a first color, and a second portion of the at least some of the threads is a second color that differs from the first color;
a first demarcation line, which corresponds to where the first color ends, defines a first perimeter shape of a haircut; and
a second demarcation line, which corresponds to where the second color ends, defines a second perimeter shape of a haircut.

23. The method of claim 21, wherein:
the threads include a line having a first color, which corresponds to a first demarcation line that defines a first perimeter shape;
the threads include a line having a second color, which corresponds to a second demarcation line that defines a second perimeter shape; and
the first and second colors differ from one another.

24. The method 21, further comprising at least one of:
adjusting a length of the spine prior to the cutting at step (c); or
adjusting a length of at least some of the threads prior to the cutting at step (c).
